(19) United States
(12) Patent Application Publication
(10) Pub. No.: US 2002/0106557 A1
(43) Pub. Date: Aug. 8, 2002

(54) Separator assembly for use in a recombinant battery

(76) Inventors: Graeme Fraser-Bell, Wirral (GB); Steven Carl Gerts, Corvallis, OR (US); Richard W. Pekala, Corvallis, OR (US); Daniel E. Weerts, Corvallis, OR (US)

Correspondence Address: STOEL RIVES LLP, 900 SW FIFTH AVENUE, SUITE 2600, PORTLAND, OR, 97204, US

(21) Appl. No.: 09/957,650

(22) Filed: Sep. 19, 2001

Related U.S. Application Data
(60) Provisional application No. 60/233,802, filed on Sep. 19, 2000.

(51) Int. Cl. H01M 2/16; H01M 2/18

(52) U.S. Cl. 429/145; 429/136; 429/250; 429/251; 429/252

(57) ABSTRACT

A battery separator assembly for use in a high-power recombinant battery has increased puncture resistance, mechanical integrity, and oxygen inhibition and includes an absorptive non-woven layer of material adhered to a microporous polymeric layer. The absorptive non-woven layer of material preferably includes absorbent glass mat (AGM), and the microporous polymeric layer preferably includes ultrahigh molecular weight polyethylene (UHMWPE). In a first preferred embodiment, the absorptive non-woven layer of material is positioned adjacent to an electrode of a positive type. In a second preferred embodiment, the microporous polymeric layer is positioned adjacent to an electrode of a negative type. In a third preferred embodiment, an electrode, which may be either negatively or positively charged, is enveloped by a three-layer separator assembly of an ABA alternating layer type in which one of the alternating layers is of a microporous polymeric type and the other layer includes an absorptive non-woven type material.

### RELATED APPLICATIONS

This application derives priority from U.S. provisional patent application No. 60/233,802, filed Sep. 19, 2000.

### TECHNICAL FIELD

This invention relates to the field of battery separator assemblies used in recombinant batteries, and more particularly to separator assemblies with increased puncture resistance, mechanical integrity, and oxygen inhibition.

### BACKGROUND OF THE INVENTION

This invention relates to a battery separator assembly for use in a recombinant lead acid battery, also known as a sealed lead acid (SLA) battery or valve-regulated lead acid (VRLA) battery.

Two different lead acid battery designs are used commercially: the flooded cell and the recombinant cell. Both types of lead acid batteries include adjacent positive and negative electrodes that are separated from each other by a porous battery separator that prevents the adjacent electrodes from coming into physical contact and that provides space for an electrolyte.

In a flooded cell, only a small portion of the electrolyte is absorbed into the separator. Thus, the battery separator typically has ribs extending from one or both planar surfaces to provide open space for “free” electrolyte. The separator typically used in flooded cells is an extruded microporous polyethylene sheet having a backweb thickness greater than about 150 micrometers, where “backweb” refers to the thickness of the separator excluding the height of the ribs.

In a recombinant cell, the electrolyte is immobilized in an absorptive, non-woven separator that is typically composed of microglass fibers. One type of recombinant cell, the VRLA battery, optimally operates in a “starved electrolyte” condition in which sufficient electrolyte is present to provide the needed discharge capacity while the amount of electrolyte is simultaneously small enough to allow adequate void space to accommodate gas transport. One unique aspect of VRLA batteries is that the majority of the oxygen gas generated at the positive electrode during overcharge (<C/3 rate) is recombined at the negative electrode to form water.

VRLA battery separators typically include absorptive glass mat (AGM) because AGM provides excellent fluid movement and electrolyte distribution. However, AGM separators offer little control over the oxygen transport rate and recombination process. Furthermore, AGM separators exhibit low puncture resistance, which is detrimental to the operation of VRLA batteries in high vibration environments, such as within an automobile. Low puncture resistance is problematic for two reasons: (1) the incidence of short circuits increases, and (2) manufacturing costs are increased because of the fragility of the AGM sheets. Attempts to produce VRLA separators with improved puncture resistance and oxygen recombination have been limited.

One attempt, described in U.S. Pat. No. 5,376,477, entailed placing a separator assembly having three layers positioned in face-to-face relationship in a recombinant battery. The first and third layers were glass fiber mats and the second layer was a flat sheet of porous thermoplastic material, such as polyethylene, having a thickness of 250 micrometers.

A second attempt, described in U.S. Pat. No. 5,894,055, entailed placing an embossable porous polymeric battery separator, preferably microporous polyethylene, in either a flooded or recombinant cell. The separator preferably had a backweb thickness of between about 50 micrometers and about 200 micrometers. A plurality of submini-ribs extended from one or both planar faces of the backweb. When used in a recombinant cell, only one planar face of the backweb had a plurality of submini-ribs extending therefrom. The other planar face had a glass mat laminated thereto such that the polyethylene separator was between the glass mat and the adjacent electrode.

However, these attempts resulted in a decrease in the amount of active material in the battery and therefore a reduction in its overall capacity.

What is needed, therefore, is a battery separator assembly that can be implemented in a high-power recombinant battery and that has increased puncture resistance, mechanical integrity, and oxygen inhibition.

### SUMMARY OF THE INVENTION

An object of the present invention is, therefore, to provide a battery separator assembly that can be implemented in a high-power recombinant battery and that has increased puncture resistance, mechanical integrity, and oxygen inhibition.

The present invention is a separator assembly that envelops an electrode having electrical conductivity properties. The separator assembly includes an absorptive non-woven layer of material adjacent to a microporous polymeric layer. The absorptive non-woven layer of material preferably includes absorbent glass mat (AGM), and the microporous polymeric layer preferably includes ultrahigh molecular weight polyethylene (UHMWPE). The UHMWPE is of a molecular weight that provides sufficient molecular chain entanglement to form a separator assembly with improved puncture resistance as compared to prior art recombinant battery separators.

In a first preferred embodiment, a positively charged electrode is enveloped by a separator assembly in which an absorptive non-woven layer is adjacent to a microporous polymeric layer, with the former layer positioned nearer to the positively charged electrode. In a second preferred embodiment, a negatively charged electrode is enveloped by a separator assembly in which a microporous polymeric layer is adjacent to an absorptive non-woven layer, with the former layer positioned nearer to the negatively charged electrode. In a third preferred embodiment, the electrode, which may be either negatively or positively charged, is enveloped by a three-layer separator assembly of an ABA alternating layer type in which at least one of the alternating layers is of a microporous polymeric type and at least one layer is of an absorptive non-woven type.

Additional objects and advantages of this invention will be apparent from the following detailed description of the preferred embodiments which proceeds with reference to the accompanying drawings.

### BRIEF DESCRIPTION OF THE DRAWINGS

FIG. 1 is a partially broken away perspective view of a positive electrode plate enveloped by a first embodiment of the separator assembly of the present invention.

FIG. 2 is a fragmentary sectional view taken along lines 2-2 of FIG. 1.

FIG. 3 is a partially broken away perspective view of a negative electrode plate enveloped by a second preferred embodiment of the separator assembly of the present invention.

FIG. 4 is a fragmentary sectional view taken along lines 4-4 of FIG. 3.

FIG. 5 is a partially broken away perspective view of an electrode plate enveloped by a third embodiment of the separator assembly of the present invention.

FIG. 6 shows one implementation of the electrode plate and the separator assembly of FIG. 5.

### DETAILED DESCRIPTION OF PREFERRED EMBODIMENTS

Recombinant batteries contain a plurality of adjacent positively and negatively charged electrodes in the form of plates or coated foils that are separated from each other by a porous battery separator assembly that prevents the adjacent electrodes from coming into physical contact and that provides space for electrolyte transport. The number of positive and negative electrodes, the manner of inserting the electrodes and the battery separator assembly into a package, the process of adding electrolyte, and the procedure of forming the battery are all well known in the field of recombinant lead acid battery manufacturing. The present invention is a separator assembly having multiple layers of material positioned adjacent to each other. The separator assembly of the present invention envelops an electrode and includes an absorptive non-woven layer and a microporous polymeric layer. As used herein, the term “envelop” refers to enclosing at least a portion of an electrode with a separator assembly.

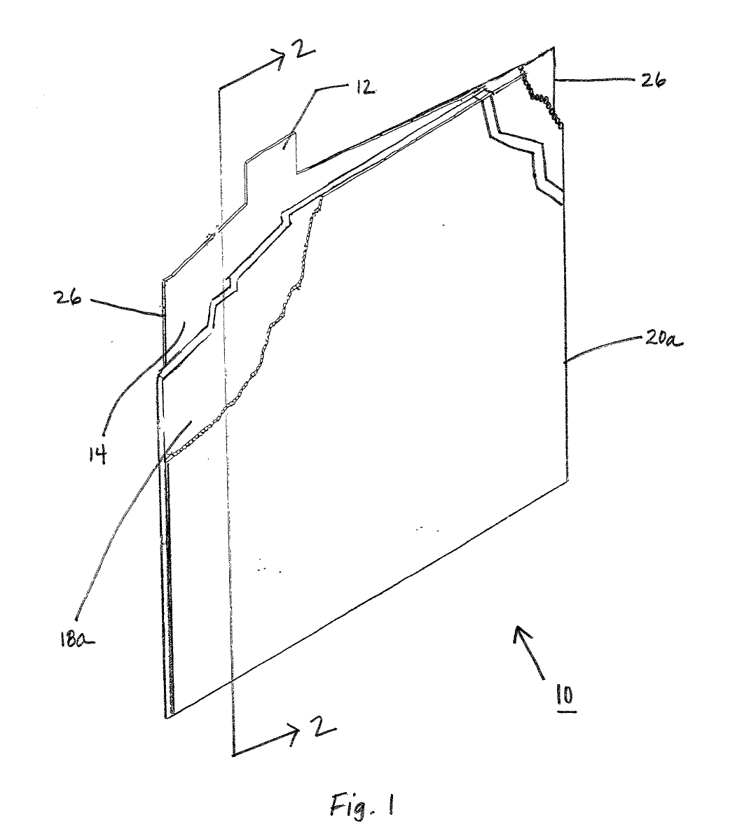

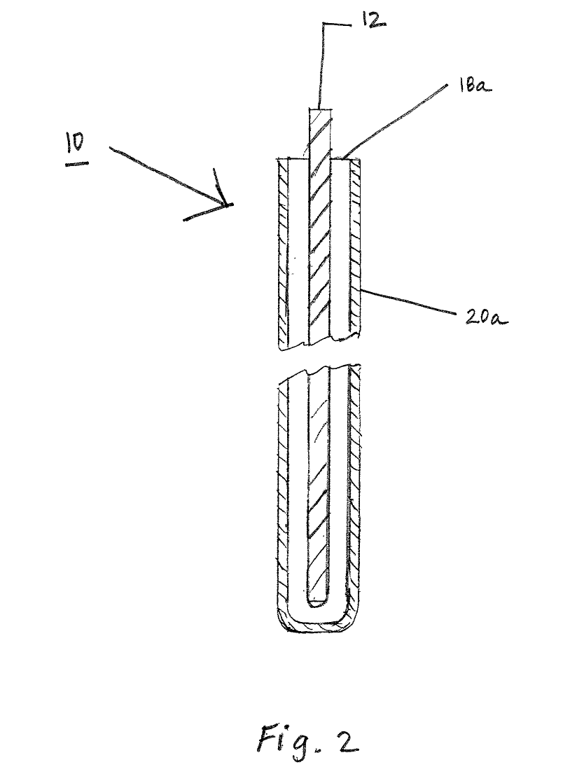

FIGS. 1 and 2 show, respectively, a partially broken-up perspective view and a cross-sectional side view of a first preferred embodiment of the separator assembly of the present invention. As shown in FIGS. 1 and 2, separator assembly 10 includes a positive electrode 12 that has a major surface 14 adjacent to a first layer 18a that includes an absorptive non-woven material. First layer 18a is adjacent to a second layer 20a that includes a microporous polymeric material. Thus first layer 18a is positioned closer to positive electrode 12 than second layer 20a.

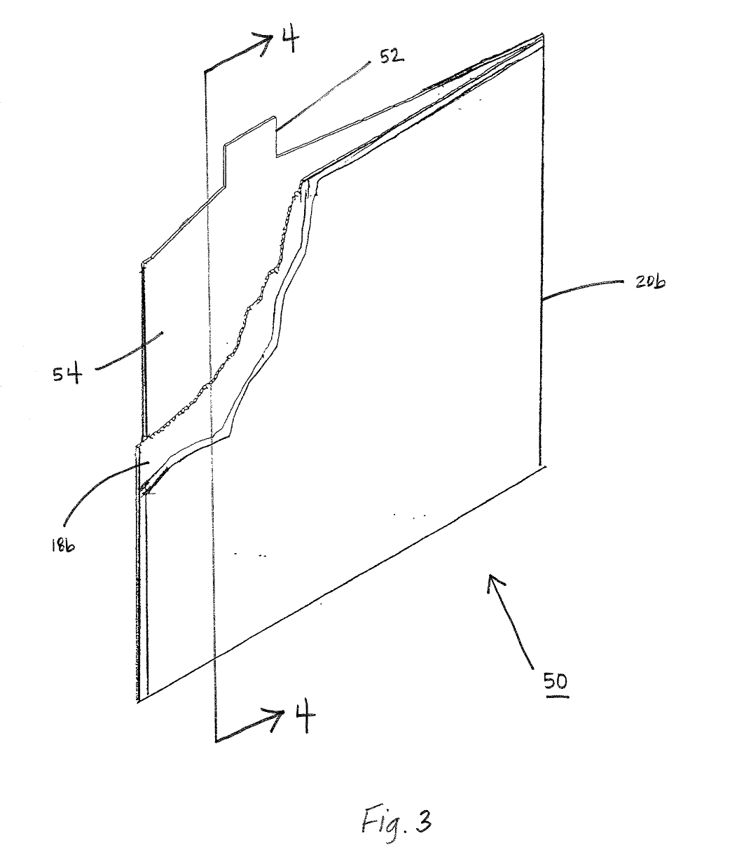

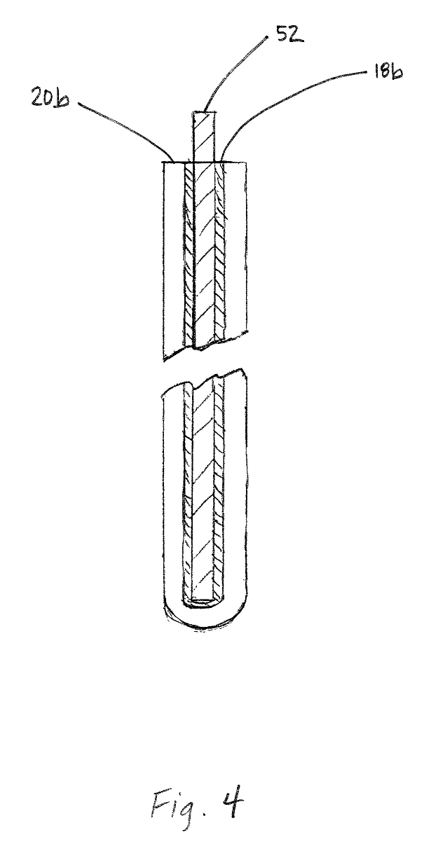

FIGS. 3 and 4 show, respectively, a partially broken-up perspective view and a cross-sectional side view of a second preferred embodiment of the separator assembly of the present invention. As shown in FIGS. 3 and 4, separator assembly 50 includes negative electrode 52, which has a major surface 54 that is adjacent to a first layer 18b that includes a microporous polymeric material. First layer 18b is adjacent to a second layer 20b that includes an absorptive non-woven material. Thus second layer 20b is positioned closer to negative electrode 52.

A preferred absorptive non-woven material is absorbent glass mat (AGM) having a porosity that is greater than about 90% by volume, a basis weight of between about 50 grams/square meter and about 400 grams/square meter, and a thickness of between about 250 microns and about 3000 microns. Other exemplary absorptive non-woven materials that can be implemented in the separator assembly of the present invention include ceramic and glass mats as well as composites made from glass and polymeric fibers.

A preferred microporous polymeric material is a flat sheet of microporous polymeric material, i.e., a sheet that has no ribs extending from either planar surface and has a thickness of between about 20 microns and about 50 microns, preferably between about 25 microns and about 50 microns. However, microporous polymeric layers 20a and 18b may have any thickness that increases the puncture resistance of the separator assembly while maintaining the desired electrical resistivity of the separator assembly. Microporous polymeric layers 20a and 18b inhibit oxygen transfer from the positive to the negative electrode plate because microporous polymeric layers 20a and 18b are substantially less porous than absorptive non-woven layers 18a and 20b.

Microporous polymeric layers 20a and 18b preferably have a porosity that is less than the porosity of absorptive non-woven layers 18a and 20b, i.e., less than 90% by volume, and more preferably between about 25% and about 80% by volume.

Exemplary polymer materials that may be included in microporous polymeric layers 20a and 18b include polypropylene, polyethylene, poly-1-methylpentene, and polyhexene. Microporous polymeric layers 20a and 18b preferably contain a microporous polyolefin, more preferably ultrahigh molecular weight polyethylene (UHMWPE). A preferred UHMWPE has an intrinsic viscosity of at least 10 deciliters/gram, and preferably greater than about 14-18 deciliters/gram. There is no upper limit for the preferred intrinsic viscosity of the UHMWPE, however current commercially available UHMWPEs have an upper intrinsic viscosity limit of about 29 deciliters/gram.

UHMWPE sheets can be formed by extruding a mixture of UHMWPE, a surfactant such as silica, processing oil, and various minor ingredients through a slot die, calendering the extruded web substantially to its desired thickness, extracting a substantial amount of the processing oil with a solvent, and drying the web. UHMWPE sheets containing silica are hydrophilic to the aqueous electrolyte used in recombinant batteries, i.e., are “wettable” by the electrolyte. Where a hydrophilic layer is desired, silica is typically present in an amount between about 20% and about 85% by weight and the resulting UHMWPE sheet preferably has a porosity that is between about 50% and about 65%. Alternatively, UHMWPE sheets can be formed without silica, in which event the resulting sheets are hydrophobic to the aqueous electrolyte used in recombinant batteries, i.e., are not “wettable” by the electrolyte. These non-wettable sheets preferably have a porosity that is between about 35% and about 50%. In both cases, the resultant microporous polymeric layer may contain up to 20% residual processing oil.

Alternatively, the AMG and UHMWPE layers can be adhesively bonded, using a small amount of adhesive, prior to the enveloping process.

The preferred first and second embodiments of the separator assembly of the present invention are manufactured by (1) enveloping the electrode with the layer of the separator assembly that is adjacent to the electrode; (2) enveloping the resultant electrode and single-layer separator assembly with the second layer of the separator assembly such that the second layer is adjacent to the first layer of the separator assembly; (3) the first and second layers are then cut to the appropriate dimensions; and (4) the enveloped electrodes are stacked in a cell package such that the type of electrical conductivity of each plate alternates (i.e., positive/negative/positive/negative etc.).

Enveloping the electrodes may be accomplished using a commercially available enveloping machine that unwinds the first and second layers from their respective rolls. The enveloping machine then wraps the appropriate layer around both planar surfaces of the electrode and cuts the separator assembly to the desired dimensions.

The widths of the first and second layers (i.e., the distance between longitudinal side edges 26 of the electrodes) are substantially the same width as the electrode. However, if the user wishes to seal the separator assembly such that the separator assembly fully envelops the electrode, the width of the second layer may be greater than the width of the electrode and the width of the first layer. In such an embodiment, the longitudinal edges of the second layer would extend beyond longitudinal edges 26 of the electrode and the longitudinal edges of the first layer so that the longitudinal edges of the second layer, which are in face-to-face relationship after being folded around the electrode, may be bonded to each other and thereby form a pouch around the fully enveloped electrode. The fully enveloped electrode may be sealed along the lower portion, the upper portion, or along the longitudinal side edges of the electrode/separator assembly combination. The machine preferably seals the separator assembly using a plurality of mechanical seal impressions formed by pressure bonding and/or ultrasonic bonding.

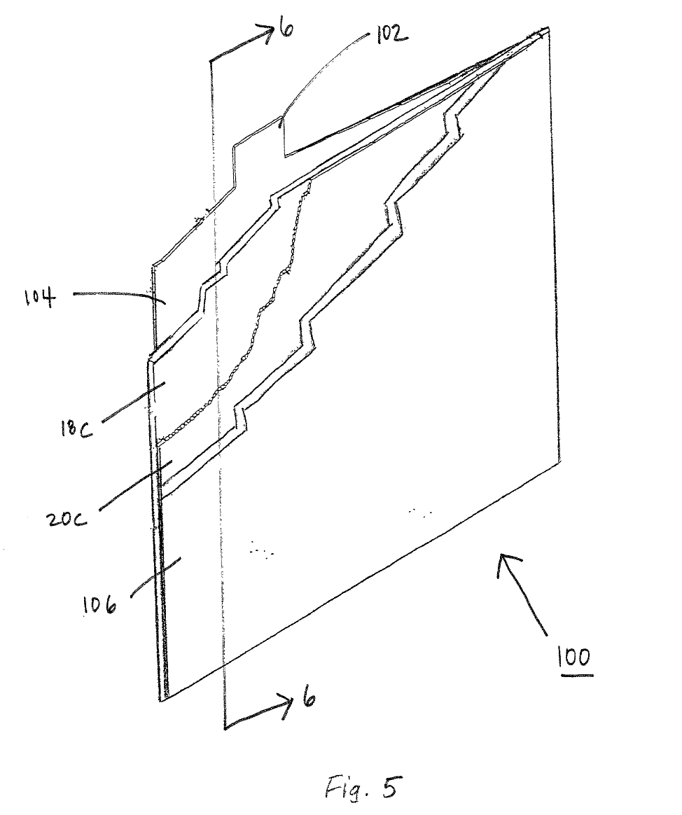

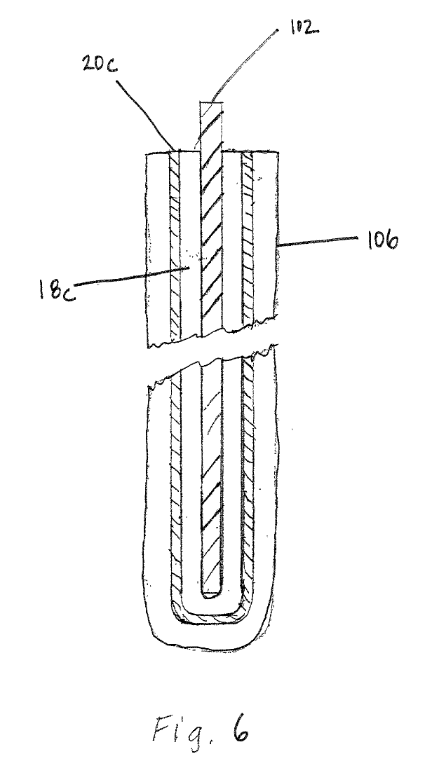

FIGS. 5 and 6 show, respectively, a partially broken-up perspective view and a cross-sectional side view of one exemplary implementation of a third embodiment of the separator assembly of the present invention. As shown in FIG. 5, separator assembly 100 includes an electrode 102, which may be either positively or negatively charged, that has a major surface 104 adjacent to a first layer 18c adjacent to a second layer 20c adjacent to a third layer 106 that is of the same type as first layer 18c. Thus electrode 102 is enveloped in an ABA structure, as compared to the AB structures of the first and second preferred embodiments depicted in FIGS. 1-4.

As shown in FIG. 6, one implementation of the third preferred embodiment of the present invention includes a positively charged electrode enveloped by first and third layers that include an absorbent non-woven material and that are each adjacent to a second layer that includes a microporous polymeric material.

The following examples describe the construction of various embodiments of the separator assembly of the present invention. The following examples also report some of the chemical and physical properties of the separator assemblies.

### EXAMPLE 1

In a first trial, an AGM sheet (1300 μm thick; 92% porosity; 30 g/m² basis weight; manufactured by Bernard Dumas, S.A.) was lightly sprayed with an adhesive (Super 77™ adhesive manufactures by 3M Corp.) on one face and then joined to a UHMWPE web (25 μm thick; 45% porosity; 12.8 g/m² basis weight; Teklon™ manufactured by Entek Membranes LLC, Lebanon, Oreg.) to form a two-layer separator assembly for use in a VRLA battery.

In a second trial, a second AGM sheet was attached to another face of the UHMWPE web in the separator assembly formed in the first trial to form a three-layer separator assembly.

Table I shows that the multilayer separator assemblies formed in the first and second trials of Example 1 display improved mechanical properties as compared to a separator assembly containing only a single layer of AGM.

TABLE I
Mechanical Properties of MultiLayer Separator Assemblies.

| | AGM | UHMWPE/AGM | AGM/UHMWPE/AGM |
|---|---|---|---|
| # layers | 1 | 2 | 3 |
| MD* tensile | 1065 | 4666 | 4769 |
| load-at-break (g) | | | |
| MD* elongation (%) | 1 | 34 | 32 |
| TD** tensile | 743 | 1940 | 2000 |
| load-at-break (g) | | | |
| TD** elongation | 2 | 143 | 168 |
| (%) | | | |
| Puncture | 222 | 962 | 1120 |
| resistance† (g) | | | |

*MD refers to the machine direction
**TD refers to the transverse direction
†Measured on a 1.9 mm diameter pin with a crosshead speed of 508 mm/min.

### EXAMPLE 2

An UHMWPE web of the type described in Example 1 was dip-coated with non-ionic surfactant (2% w/w solution, Tergitol NP-4). The surfactant-coated web was then joined to an AGM sheet of the type described in Example 1 to form a two-layer separator assembly for use in a VRLA battery. The surfactant rendered the UHMWPE web wettable in 38% sulfuric acid (specific gravity=1.28).

### EXAMPLE 3

An UHMWPE web of the type described in Example 1 was selectively spray-coated with non-ionic surfactant (2% w/w solution, Tergitol NP-4) to form a pattern of coated and uncoated regions on the surface of the UHMWPE web. The resultant web was then joined to an AGM sheet of the type described in Example 1 to form a two-layer separator assembly for use in a VRLA battery. The surfactant rendered selected regions of the UHMWPE web wettable in 38% sulfuric acid (specific gravity=1.28).

### EXAMPLE 4

Two of the UHMWPE webs of the type described in Example 1 were heat-laminated in a hot-air oven at 140° C. to form a 50 μm thick web. The resultant web was subsequently joined to an AGM sheet of the type described in Example 1 to form a multilayer separator assembly for use in a VRLA battery.

It will be obvious to those having skill in the art that many changes may be made to the details of the above-described embodiment of this invention without departing from the underlying principles thereof. The scope of the present invention should, therefore, be determined only by the following claims.

1. A separator assembly for use in a recombinant battery having multiple electrodes that are wound or stacked in a package filled with an electrolyte, at least one of the electrodes having a major surface to which the separator assembly is adjacent, comprising:
an absorptive non-woven layer of material having first and second major surfaces and a porosity adequate to absorb an electrolyte; and
a microporous polymeric layer having a major surface adjacent to one of the first and second major surfaces of the absorptive non-woven layer of material and a thickness of less than 50 microns.

2. The separator assembly of claim 1, in which the absorptive non-woven layer of material includes polymeric fiber, glass fiber, ceramic fiber, and combinations thereof.

3. The separator assembly of claim 2, in which the absorptive non-woven layer of material includes microglass fiber.

4. The separator assembly of claim 1, in which the porosity of the absorptive non-woven layer of material is between about 80% and about 98%.

5. The separator assembly of claim 1, in which the microporous polymeric layer includes a polyolefin.

6. The separator assembly of claim 5, in which the microporous polymeric layer includes a polyolefin selected from the group consisting essentially of polypropylene, polyethylene, poly-1-methyl pentene, and polyhexene.

7. The separator assembly of claim 1, in which the microporous polymeric layer includes an ultrahigh molecular weight polyolefin.

8. The separator assembly of claim 7, in which the polyolefin is ultrahigh molecular weight polyethylene.

9. The separator assembly of claim 1, in which the microporous polymeric layer has a thickness that ranges from between about 20 microns and about 50 microns.

10. The separator assembly of claim 1, in which the porosity of the microporous polymeric layer is less than the porosity of the absorptive non-woven layer of material.

11. The separator assembly of claim 1, in which the microporous polymeric layer has a porosity that is between about 20% and about 80%.

12. The separator assembly of claim 1, in which the absorptive non-woven layer of material and the microporous polymeric layer are sealed to fully envelop one of the multiple electrodes.

13. The separator assembly of claim 1, in which the microporous polymeric layer is wettable with electrolyte.

14. The separator assembly of claim 13, in which the microporous polymeric layer has a porosity that is between about 50% and about 65%.

15. The separator assembly of claim 1, in which the microporous polymeric layer has a porosity that is between about 35% and about 50%.

16. The separator assembly of claim 15, in which the microporous polymeric layer includes a surfactant.

17. The separator assembly of claim 15, in which the microporous polymeric layer is of a hydrophobic type.

18. The separator assembly of claim 1, in which the electrode plate is positively charged and is positioned in face-to-face contact with the absorptive non-woven layer of material.

19. The separator assembly of claim 1, in which the electrode plate is negatively charged and is positioned in face-to-face contact with the microporous polymeric layer.

20. The separator assembly of claim 1, in which the microporous polymeric layer includes an inorganic filler.

21. The separator assembly of claim 20, in which the inorganic filler includes finely divided amorphous silica particles.

22. A recombinant battery comprising:
multiple positive and negative electrodes;
at least one of the electrodes positioned in proximity to a separator assembly including an absorptive non-woven layer of material having a first major surface adjacent to a microporous polymeric layer having a thickness of less than 50 microns; and
an electrolyte that is at least partially absorbed by the electrodes.

23. The recombinant battery of claim 22, in which the absorptive non-woven layer of material includes absorptive glass mat and the microporous polymeric layer includes a polyolefin.
